(19) United States
(12) Patent Application Publication
(10) Pub. No.: US 2025/0212717 A1
(43) Pub. Date: Jul. 3, 2025

(54) SOWING UNIT FOR A PRECISION SEEDER

(71) Applicant: AMAZONEN-WERKE H. DREYER SE & CO. KG, Hasbergen (DE)

(72) Inventors: Christian HENKE, Burgwedel (DE); Jens KOCH, Uelzen (DE); Daniel MERTENS, Oldenburg (DE)

(21) Appl. No.: 18/851,409

(22) PCT Filed: Mar. 16, 2023
(86) PCT No.: PCT/EP2023/056693

§ 371 Date: Feb. 5, 2025

(30) Foreign Application Priority Data
Mar. 29, 2022 (DE) 10 2022 107 317.3

(51) Int. Cl. A01C 5/06; A01B 63/00; A01C 7/04; A01C 7/06; A01C 7/20

(52) U.S. Cl. CPC A01C 5/062; A01C 5/068; A01C 7/206; A01B 63/008; A01C 7/042; A01C 7/06

(57) ABSTRACT

The invention relates to a sowing unit (10) for a precision seeder, comprising: a bracket (12); a tine share (24) arranged on the bracket (12) for producing a placement furrow for grains of seed, which furrow extends in the direction of travel, in the soil of an agricultural area; a separation device (18) arranged on the bracket (12) for separating grains of seed; a placement device (20) arranged on the bracket (12) for placing the grains of seed which have been separated by the separation device (18) into the placement furrow produced by the tine share (24); and a rolling body (26, 36, 38a, 38b) arranged on the bracket (12) for supporting the sowing unit (10) against the soil of the agricultural area and/or for depth guidance of the tine share (24).

The invention relates to a sowing unit for a precision seeder according to the preamble of claim 1 and to a precision seeder according to the preamble of claim 15.

Sowing units of precision seeders usually have a furrow former which is arranged between two cutting disks of the sowing unit. The furrow former is used to stabilize and shape the placement furrow opened by the cutting disks.

Such furrow formers are usually “trailing” relative to the soil, i.e. their front edge forms an acute angle with the direction of travel vector, so that the furrow former drags over the soil.

The publication DE 10 2005 037 062 A1 discloses a share unit equipped with disks and tines so that different types of seed can be sown. The document DE 42 37 093 A1 describes how a tine share can be used alone or in combination with a disk. The publication EP 2 950 629 B1 describes a furrow former which is to be used together with disks and is guided by a depth guidance roller.

Furthermore, from the publication EP 0 202 229 B1 a precision seeder with row units is known, wherein the row units are equipped with a furrow former. The document EP 0 369 766 B1 describes a tine seeder with a positive pressure separation means. The publications US 2005/0274309 A1 and RU 204018 U1 also describe furrow formers.

When using mulching shares with cutting disks and a furrow former, under direct seeding conditions and conditions with a high proportion of organic material, the organic material might not be cleanly cut and pressed into the furrow. As a result, the seed is deposited on the organic material and has no contact with the soil, resulting in reduced field emergence.

The object underlying the invention is to improve the single-grain placement under direct seeding conditions and conditions with a high proportion of organic material.

The object is achieved by a sowing unit of the type mentioned at the outset, wherein the tine share of the sowing unit according to the invention has a furrow opening edge on the front side and enclosing an obtuse angle with the direction of travel vector for opening the placement furrow.

To create the furrow, no combination of cutting disks and furrow formers is used, but rather a tine share that works in a “gripping” manner. The fact that the front furrow opening edge runs at an obtuse angle to the direction of travel results in a positive cutting angle. By using tine shares that work in a “gripping” manner, prior soil preparation, as with direct sowing, is no longer necessary, which is particularly advantageous in areas at risk of erosion. In addition, the placement furrow is cleared better, especially of organic material, which improves the soil connection of the seed. The tine share works in a “gripping” manner so that the organic material is not pressed into the soil, but is cleared out of the furrow by the positive cutting angle. Furthermore, the positive cutting angle pulls the tine share into the soil, which means that less share pressure is required than with a single-seed share with coulter disks. An additional share pressure application therefore only needs to apply a slight pressure force to the tine share and can therefore be carried out much more easily and cost-effectively. In addition, there is significantly less soil movement compared to a disk share, so that weeds and grasses are not stimulated to germinate, or at least are stimulated to a significantly lesser extent. In addition, a narrower furrow can be created compared to a double disk share, so that less soil material is moved and the risk of germination of weeds and grasses is further reduced. Furthermore, the costs for the sowing unit are reduced because the coulter disks including bearings are no longer required. In addition, the self-retracting effect of the tine share is beneficial for depth guidance, as the often complex share pressure control using hydraulics can be simplified and the share itself can be built more easily. Such tine shares are usually only used for direct sowing or mulch sowing without prior soil cultivation. In single-seed sowing with sowing units that have a rolling body to support the sowing unit against the soil, only tine-like furrow formers have been used to form an already opened placement furrow, wherein these tine-like furrow formers have a furrow forming edge on the front that runs at an acute angle to the direction of travel. These tine-like furrow formers therefore work in a “trailing” manner. The sowing unit can be a row unit for a precision seeder.

In a preferred embodiment of the sowing unit according to the invention, the tine share has an opening portion located in a front region of the tine share, wherein the furrow opening edge is arranged in the opening portion. The tine share preferably has a forming portion with one or more forming surfaces behind the opening portion in the direction of travel for forming the placement furrow opened by the furrow opening edge. The one or more forming surfaces within the forming portion press the soil outwards on the lateral furrow surfaces so that a furrow wall is formed and the placement furrow is stabilized and formed.

In another preferred embodiment of the sowing unit according to the invention, the tine share has a reconsolidation portion with one or more reconsolidation surfaces for reconsolidating the placement furrow opened by the furrow opening edge and/or formed by the one or more forming surfaces in the direction of travel behind the opening portion and/or the forming portion. The front furrow opening edge of the tine share works in a gripping manner, breaking the earth out of the ground more effectively than tine shares working in a trailing manner. For this reason, the furrow bottom of a placement furrow that was opened with a front furrow opening edge arranged in a gripping position is less even than the furrow bottom of a placement furrow that was created with a tine share standing in a trailing position. The impairments in terms of the differences in placement depth and the quality of the catch resulting from the use of a tine share with a front furrow opening edge that is arranged in a gripping position must be compensated for by targeted recompaction. In this context, the reconsolidation portion ensures an appropriate redistribution of the soil and the creation of a uniform furrow bottom. In addition, the soil connection of the seed is improved. Preferably, the opening portion is narrower than the forming portion and/or reconsolidation portion, thereby improving the clearing, stabilizing and reconsolidation properties of the tine share. A bottom-side reconsolidation surface is preferably arranged in such a way that it is guided through the soil slightly deeper, for example 1 mm to 4 mm deeper, than the furrow opening edge, so that the soil in the bottom area of the placement furrow is compressed and the placement furrow is thus consolidated, stabilized and shaped. The reconsolidation areas in the reconsolidation portion therefore preferably ensure compression of the soil at the bottom of the furrow.

The sowing unit according to the invention is further advantageously developed in that the opening portion, the forming portion and/or the reconsolidation portion are integral components of a one-piece tine body of the tine share. The one-piece tine body can be made of metal or a metal alloy, for example. Between the opening portion and the reconsolidation portion, in particular between the opening portion and the forming portion, the one-piece tine body preferably has a material bridge. A fastening member, in particular a screw, preferably extends through the material bridge, and is used to fasten the tine share to the bracket. Above the material bridge there is preferably a tapered, in particular conical receiving and positioning area for receiving, in particular for form-fittingly receiving, a fastening portion of the bracket. The tapered receiving and positioning area ensures that the tine body is pre-positioned in relation to the bracket during assembly of the tine body, whereby a receiving opening for the fastening member extending through the material bridge is aligned with a threaded portion in the bracket.

In a further preferred embodiment of the sowing unit according to the invention, the placement device has a placement channel for the separated grains of seed and the placement channel is attached to the tine share. The placement channel is preferably arranged on the tine share in such a way that the placement channel cannot be damaged by the placement furrow and/or soil components, such as stones. In particular, the placement channel is arranged in the direction of travel behind the tine share in the slipstream of the tine share. The placement channel can be a seed channel, in particular a firing channel. The separated grains of seed are discharged through a discharge opening at the bottom end of the placement channel in the direction of the placement furrow.

In another preferred embodiment of the sowing unit according to the invention, the separation device is designed to be operated based on differential pressure. Preferably, the separation device is designed to carry out positive pressure separation. The positive pressure separation allows an increase in driving speed while at the same time improving the longitudinal distribution of the seed on the agricultural area. In differential pressure-based separation, separation takes place within a separation housing of the separation device. A separating element, for example a perforated disk, can be arranged in the separation housing and divides the interior of the separation housing into two areas. The first area, where the grains are located, always has a higher pressure than a second area. For this purpose, either the second area is provided with a negative pressure or the first grain-carrying area is provided with a positive pressure. In this respect, a distinction is made between negative pressure separation and positive pressure separation. Due to the pressure difference, individual seeds are pressed into the perforations of the disk, for example, which run through a seed reservoir located in the lower area of the separation housing. Excess grains that are not pressed into the perforations of the disk are, for example, stripped off the disk. The separated grains in the perforations of the disk are released from the disk when a grain outlet is reached by interrupting the pressure difference. The pressure interruption element used to interrupt the pressure difference is arranged on the non-grain-bearing side and causes the perforations to be covered. In the case of positive pressure separation, the separated grains are additionally accelerated in the placement channel by the positive pressure prevailing in the grain-carrying area, so that the separated grains are shot into the furrow. The separated grains can, for example, be shot under a catching element arranged behind the placement opening of the placement channel so that the grains are immediately clamped there and cannot jump out of the placement furrow. The catching element of the sowing unit can, for example, be a catching roller, which is designed as an intermediate pressure roller. In this case, the tine share is combined with an intermediate pressure roller.

In a further embodiment, the sowing unit according to the invention has a seed storage container arranged on the bracket and connected to the separation device via a seed conveying path. The seed storage container can be fillable manually. The seed storage container can also be an intermediate container which is supplied with seed from a central container continuously or as required. Alternatively or additionally, the sowing unit can have a seed inlet arranged on the bracket, which can be connected to a central container of a seeder and is designed to be fed with seed from the central container continuously or as needed. The seed supply can be part of a nursing system.

In a particularly preferred embodiment, the sowing unit according to the invention has a catching element arranged on the bracket for braking and/or pressing the grains of seed placed in the placement furrow via the placement device. The catching element can be a catching roller running behind the tine share and the placement channel. The catching element preferably improves the soil connection of the seed. The catching element can also be a seed setter arranged behind the tine share and the placement channel. The seed setter can be pre-tensioned relative to the soil and designed to press the seed into the soil in a grazing manner. The seed setter can be designed to align the seed lying in the placement furrow, in particular in the longitudinal direction. The catching element may comprise one or more sensors for detecting placement conditions and/or soil properties. For example, the catching element comprises one or more sensors for detecting the temperature, humidity and/or electrical conductivity of the soil. Using the sensor data, the depth guidance of the sowing unit can be adapted to the soil conditions by keeping the respective measured values within a range that is representative of the placement depth to be maintained.

In a further preferred embodiment of the sowing unit according to the invention, the rolling body is designed as a depth guidance roller running behind the tine share in the direction of travel or as a support roller or bracket roller running laterally next to the tine share. By using a depth guidance roller running behind the tine share, the overall costs are significantly reduced by eliminating the need for support rollers. Due to the lack of lateral support rollers, a depth guidance roller running in the direction of travel behind the tine share also leads to an improved material flow. A support roller running to the side of the tine share or a stirrup-edged plate reduces the amount of soil thrown out and thus the formation of ridges. In addition, depth guidance is improved because the support roller or the stirrup-edged plate is positioned close to the placement location. Lateral stirrup-edged plates can also pull organic material through.

It is also advantageous to have a sowing unit according to the invention which has a follow-up tool arranged on the bracket for closing the placement furrow. The follow-up tool can be a closer, in particular a disk closer. The disk closer can, for example, be designed in such a way that the furrow side wall is broken up. The follow-up tool can also be a pair of rollers, wherein the rollers can be positioned in a V-shape relative to each other.

The sowing unit according to the invention is further advantageously further developed by at least one preliminary tool arranged on the bracket, wherein the preliminary tool is arranged in front of the tine share in the direction of travel. The preliminary tool can, for example, be a fertilizer share for depositing fertilizer. Using the fertilizer share, the fertilizer can be moved sideways or placed at a different depth than the seed, for example. One or more preliminary tools designed as cutting disks can also be arranged on the bracket. Preferably, a single cutting disk is used as a preliminary tool. Furthermore, one or more preliminary tools designed as clearing elements can be arranged on the bracket. The clearing elements can be star clearers, clod clearers or clearing chisels. The star clearer can, for example, comprise one clearing star or two clearing stars.

Furthermore, a sowing unit according to the invention is preferred in which at least one fertilizer dosing and/or fertilizer application device is arranged on the bracket and is preferably arranged in front of the tine share in the direction of travel. Either fertilizer or another active agent can be applied via the fertilizer dosing and/or fertilizer application device. The fertilizer application device can also be suitable for spreading seed. The fertilizer dosing and/or fertilizer application device may comprise a portioning device for producing fertilizer portions. The portioning device can have a portioning element that can be driven in rotation and which combines fertilizer bodies located in a portioning chamber of the portioning device to form a fertilizer portion during a rotational movement. The fertilizer dosing and/or fertilizer application device can also be designed for dosing and/or applying microgranules. Furthermore, the fertilizer dosing and/or fertilizer application device can have an additional placement channel, for example a placement tube, via which micro-fertilizers, insecticides or seed can be delivered in front of a pressure roller into the placement furrow and/or an additional placement furrow.

The sowing unit according to the invention is further advantageously developed in that the bracket is designed as a multi-part support frame. The bracket may comprise a parallelogram linkage connected to a main frame. The height of the bracket in relation to the main frame can be changed via the parallelogram linkage, so that the guidance height or the guidance depth of the sowing unit above the soil of the agricultural area can be changed. If a seeder has several sowing units attached to the main frame, the sowing units can be lifted out independently of each other, for example individually, or together.

The sowing unit according to the invention is further advantageously developed by a share pressure detection device, wherein the contact pressure of the sowing unit or of a part of the sowing unit on the soil of the agricultural area can be detected, in particular by sensor, by means of the share pressure detection device. Alternatively or additionally, the sowing unit comprises a share pressure adjustment device, by means of which the contact pressure of the sowing unit or of a part of the sowing unit on the soil of the agricultural area can be adjusted, in particular controlled. Alternatively or additionally, the sowing unit has a placement depth adjustment device by means of which the guide depth of the tine share can be adjusted to change the furrow depth of the placement furrow. In addition, the sowing unit can comprise one or more soil sensors by means of which properties of the soil can be detected in a sensor-based manner. For example, the sowing unit comprises one or more sensors for detecting the temperature, humidity and/or electrical conductivity of the soil. Using the sensor data, the depth guidance of the sowing unit for example can be adapted to the soil conditions by keeping the respective measured values within a range that is representative of the placement depth to be maintained.

The problem addressed by the invention is further solved by a precision seeder of the type mentioned at the outset, wherein one, more or all sowing units of the precision seeder according to the invention are designed according to any one of the embodiments described above. With regard to the advantages and modifications of the precision seeder according to the invention, reference is made to the advantages and modifications of the sowing unit according to the invention.

Preferred embodiments of the invention are explained and described in more detail below with reference to the accompanying drawings, In the figures:

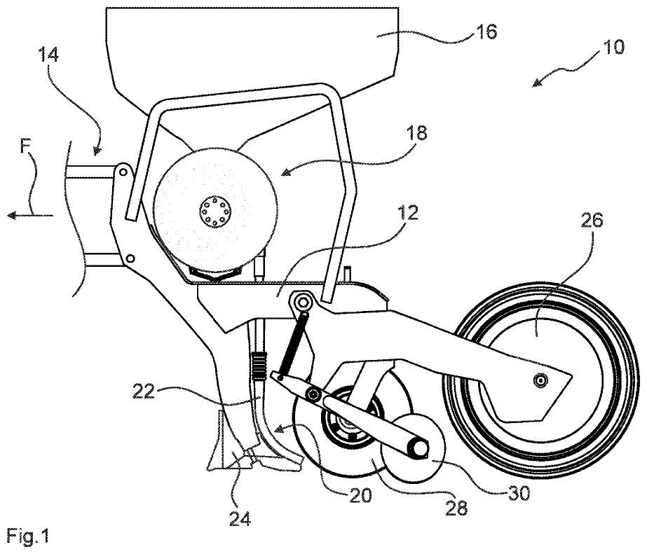

FIG. 1 shows a schematic side view of an exemplary embodiment of the sowing unit according to the invention;

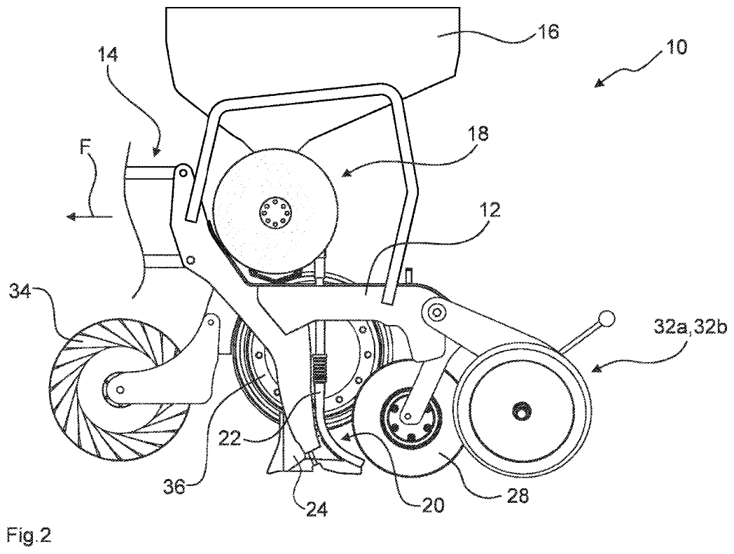

FIG. 2 shows a schematic side view of a further exemplary embodiment of the sowing unit according to the invention;

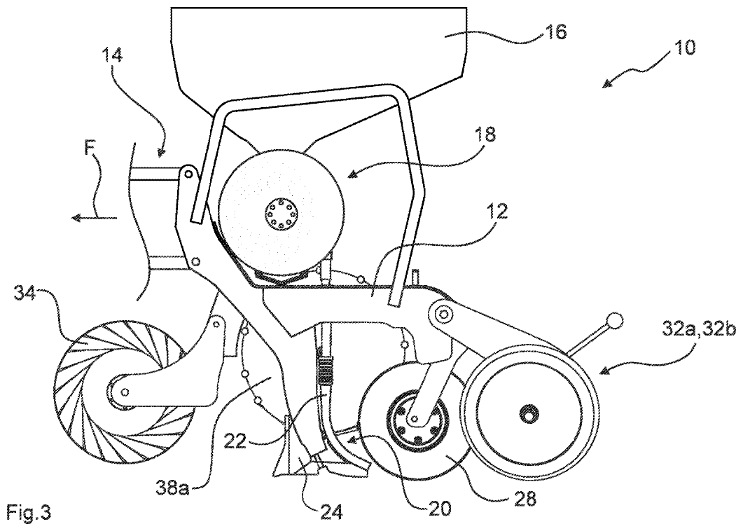

FIG. 3 shows a schematic side view of the sowing unit according to the invention;

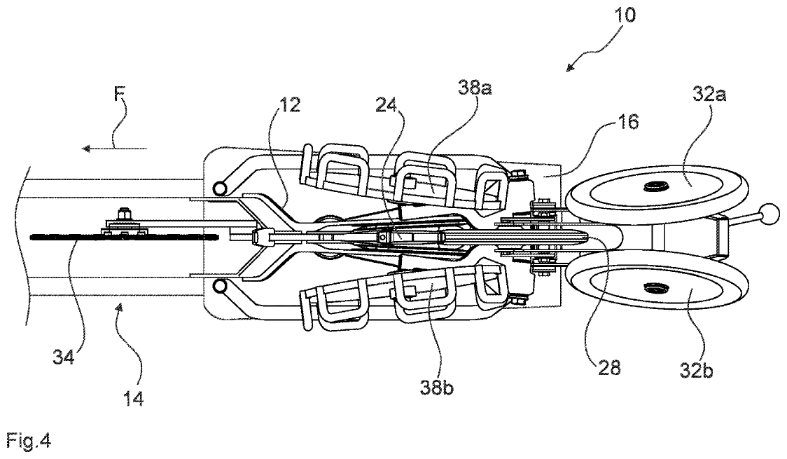

FIG. 4 shows the sowing unit shown in FIG. 3 in a schematic representation from below;

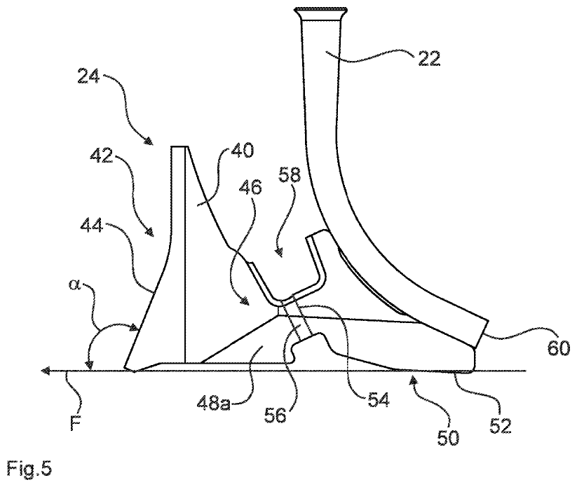

FIG. 5 shows a tine share of a sowing unit according to the invention in a schematic side view;

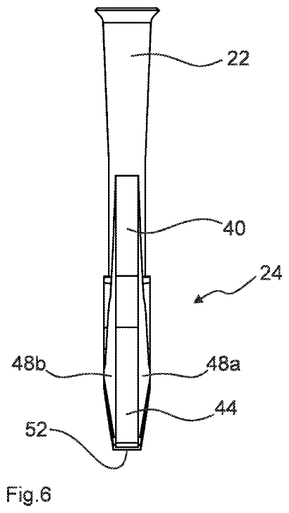

FIG. 6 shows a schematic front view of the tine share shown in FIG. 5; and

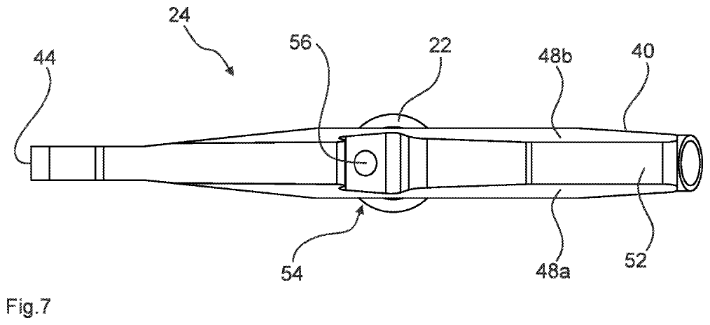

FIG. 7 shows a schematic representation from below of the tine share shown in FIG. 5.

FIG. 1 shows a sowing unit 10 of a precision seeder designed as a row unit. The sowing unit 10 comprises a bracket 12, wherein the bracket 12 is designed as a welded support frame. The bracket 12 comprises a parallelogram linkage 14, via which the bracket 12 can be fastened to a main frame of the precision seeder. The parallelogram linkage 14 allows height adjustment and contour or ground adaptation of the sowing unit 10 independently of the main frame of the precision seeder. By installing suitable devices, a downward pressure force can also be applied to the bracket 12 via the parallelogram linkage 14.

A seed storage container 16 is attached to the bracket 12 and is connected to a separation device 18 via a seed conveying path. The seed container 16 is a manually fillable container. The separation device 18 serves to separate seeds, wherein the seeds separated by the separation device 18 are deposited in a placement furrow on the agricultural area via a placement device 20 fastened to the bracket 12. For this purpose, the isolated grains of seed are introduced into the placement channel 22 of the deposition device 20, which is designed as a firing channel, and are guided via the placement channel 22 in the direction of the placement furrow.

The separation device 18 can be operated based on differential pressure. The separation device 18 is designed to carry out positive pressure separation. Due to the positive pressure separation, the separated grains of seed are accelerated due to the positive pressure in the placement channel 22 and shot into the placement furrow. The separated grains are shot under a catching element 28 arranged behind the placement opening of the placement channel 22 so that the grains are immediately clamped there and cannot jump out of the placement furrow.

The placement channel 22 is attached to a tine share 24, by means of which the placement furrow for seeds extending in the direction of travel F is created in the soil of the agricultural area.

The sowing unit 10 further comprises a rolling body 26 arranged on the bracket 12 for supporting the sowing unit 10 against the soil of the agricultural area and for depth guidance of the tine share 24. The rolling body 26 is designed as a depth guidance roller running in the direction of travel F behind the tine share 14. By using the depth guidance roller 26 running behind the tine share 24, lateral support rollers can be dispensed with, resulting in an improved material flow.

Furthermore, a catching element 28 is arranged on the bracket 12 for braking and pressing the seeds deposited into the placement furrow via the placement device 20. The catching element 28 is a catching roller running behind the tine share 24 and the placement channel 22. The catching roller 28 improves the soil connection of the seed.

In order to close the placement furrow, a follow-up tool 30 designed as a disk closer is also arranged on the bracket 12. The disk closer 30 can, for example, be designed to break up the furrow side wall to cause a furrow collapse, resulting in the closure of the placement furrow.

FIG. 2 shows a sowing unit 10 in which a preliminary tool 34 is arranged on the bracket 12, wherein the preliminary tool 34 is arranged in front of the tine share 24 in the direction of travel F. In the illustrated exemplary embodiment, the preliminary tool 34 is a cutting disk. Alternatively, a fertilizer share or a clearing element can be used as a preliminary tool. To close the placement furrow, follow-up tools 32a, 32b designed as rollers are used, wherein the rollers 32a, 32b are positioned in a V-shape relative to one another so that the soil in the contact area of the rollers 32a, 32b is pressed into the placement furrow created by the tine share 24.

The rolling bodies 36 for supporting the sowing unit 10 against the ground of the agricultural area and for depth guidance of the tine share 24 are in this case designed as support rollers running laterally next to the tine share 24. The support rollers running to the side of the tine share 24 reduce the amount of soil thrown and thus the formation of ridges.

FIGS. 3 and 4 show a sowing unit 10 in which stirrup-edged plates are used as rolling bodies 38a, 38b. The stirrup-edged plates 38a, 38b run laterally next to the tine share 24. The bracket rollers 38a, 38b are positioned offset from one another in the direction of travel F and aligned in a V-shape with respect to one another, wherein the distance between the stirrup-edged plates 38a, 38b from one another decreases in the direction opposite the direction of travel F. As a result, the earth flow caused by the tine share 24 is reliably collected and conveyed back to the placement furrow.

The tine shares 24 of the sowing units 10 shown in FIG. 1 to 4 work in a gripping manner. The tine shares 24, which work in a gripping manner, clear the placement furrow more effectively of organic material, thereby improving the soil connection of the seed. Furthermore, the organic material is not pressed into the soil, as is the case with trailing tine shares. Due to the positive cutting angle, the organic material is cleared from the furrow by the tine shares 24 working in a gripping manner.

Due to the positive cutting angle of the tine shares 24, the tine shares are pulled into the soil, which also requires less share pressure than a precision sowing share with coulter disks. The self-retracting effect of the tine share 24 also supports depth guidance, as the share pressure control is simplified and the share can be constructed more lightly.

The sowing units 10 shown can also have a share pressure detection device, by means of which the contact pressure of the sowing unit 10 or a part of the sowing unit 10 on the soil of the agricultural area can be detected in a sensor-based manner. This share pressure detection device can be combined with a share pressure adjustment device, by means of which the contact pressure of the sowing unit 10 or of a part of the sowing unit 10 on the soil of the agricultural area can be adjusted, in particular controlled.

The sowing units 10 can furthermore have a placement depth adjustment device by means of which the guide depth of the respective tine share 24 can be adjusted in order to change the furrow depth of the placement furrow. Furthermore, the sowing units 10 can be equipped with one or more soil sensors, by means of which properties of the soil can be detected in a sensor-based manner.

FIGS. 5 to 7 show a tine share 24 with a one-piece tine body 40. A placement channel 22 of a placement device 20 is arranged on the tine body 40.

The tine body 40 has an opening portion 42, wherein a furrow opening edge 44 runs within the opening portion 42. The furrow opening edge 44 is located on the front of the tine body 40 and forms an obtuse angle α with the direction of travel vector F. The fact that the front furrow opening edge 44 runs at an obtuse angle α to the direction of travel F results in a positive cutting angle; the tine share 24 thus works in a gripping manner.

The opening portion 42 of the tine share 24 carrying the furrow opening edge 44 is located in a front region of the tine body 40. The tine share 24 further comprises, in the direction of travel F behind the opening portion 42, a forming portion 46 with multiple forming surfaces 48a, 48b for forming the placement furrow opened by the furrow opening edge 44. In the direction of travel F behind the opening portion 42 and the forming portion 46, the tine share 24 has a reconsolidation portion 50 with a reconsolidation surface 52 for reconsolidating the placement furrow opened by the furrow opening edge 44 and formed by the forming surfaces 48a, 48b. The reconsolidation surface 52 is guided through the soil of the agricultural area approximately 1 mm to 4 mm deeper than the furrow opening edge 44, so that the earth on the furrow surface is compressed.

Between the opening portion 42 and the reconsolidation portion 50, the tine body 40 has a material bridge 54. A recess 56 extends through the material bridge 54 to accommodate a fastening element, for example a screw. By means of the screw, the tine body 40 can be screwed to a bracket 12. Above the material bridge 54 there is located a tapered conical receiving and positioning area 58 for receiving a fastening portion of the bracket 12. Due to the tapered conical shape of the receiving and positioning area 58, the tine body 40 is positioned on the bracket 12 in such a way that the recess 56 is aligned with a threaded bore in the bracket 12. The insertion and tightening of the fastening element designed as a screw is thus considerably simplified, whereby the assembly of the tine share 24 can be considerably accelerated. The discharge opening 60 of the placement channel 22 is located approximately at the level of the rear end edge of the tine body 40 in the direction of travel.

### LIST OF REFERENCE SYMBOLS

10 sowing unit
12 bracket
14 parallelogram linkage
16 seed storage container
18 separation device
20 placement device
22 placement channel
24 tine share
26 rolling body
28 catching element
40 follow-up tool
32a, 32b follow-up tools
34 preliminary tool
36 rolling body
38a, 38b rolling body
40 tine body
42 opening portion
44 furrow opening edge
46 forming portion
48a, 48b forming surfaces
50 reconsolidation portion
52 reconsolidation surface
54 material bridge
56 recess
58 receiving and positioning area
60 discharge opening
F direction of travel vector
α angle

1. A sowing unit for a precision seeder, comprising
a bracket;
a tine share arranged on the bracket for producing a placement furrow for grains of seed, which furrow extends in the direction of travel, in the soil of an agricultural area;
a separation device arranged on the bracket for separating grains of seed;
a placement device arranged on the bracket for placing the grains of seed which have been separated by the separation device into the placement furrow produced by the tine share, and
a rolling body arranged on the bracket for supporting the sowing unit against the soil of the agricultural area and/or for depth guidance of the tine share;
wherein the tine share has a furrow opening edge on the front side and forming an obtuse angle with the direction of travel vector for opening the placement furrow.

2. The sowing unit according to claim 1,
wherein the tine share has an opening portion located in a front region of the tine share, wherein the furrow opening edge is arranged in the opening portion, wherein the tine share has a forming portion with one or more forming surfaces for forming the placement furrow opened by the furrow opening edge behind the opening portion in the direction of travel.

3. The sowing unit according to claim 1,
wherein the tine share has, in the direction of travel behind the opening portion and/or the forming portion, a reconsolidation portion with one or more reconsolidation surfaces for reconsolidating the placement furrow opened by the furrow opening edge and/or formed by the one or more forming surfaces.

4. The sowing unit according to claim 2,
wherein the opening portion, the forming portion and/or the reconsolidation portion are integral components of a one-piece tine body of the tine share.

5. The sowing unit according to claim 1,
wherein the placement device has a placement channel for the separated grains of seed and the placement channel is fastened to the tine share.

6. The sowing unit according to claim 1,
wherein the separating device is designed to be operated based on differential pressure.

7. The sowing unit according to claim 1,
by further comprising:
a seed storage container, which is arranged on the bracket and is connected to the separation device via a seed conveying path; and/or
a seed inlet, which is arranged on the bracket, can be connected to a central container of a seeder and is designed to be fed with seed from the central container continuously or as required.

8. The sowing unit according to claim 1,
further comprising at least one catching element arranged on the bracket for braking and/or pressing the grains of seed placed in the placement furrow via the placement device.

9. The sowing unit according to claim 1,
wherein the rolling body is designed as a depth guidance roller running behind the tine share in the direction of travel or as a support roller or bracket roller running laterally next to the tine share.

10. The sowing unit according to claim 1,
further comprising at least one follow-up tool arranged on the bracket for closing the placement furrow.

11. The sowing unit according to claim 1,
further comprising at least one preliminary tool, which is arranged on the bracket and is arranged in front of the tine share in the direction of travel.

12. The sowing unit according to claim 1,
further comprising at least one fertilizer dosing and/or fertilizer application device, which is arranged on the bracket and is preferably arranged in front of the tine share in the direction of travel.

13. The sowing unit according to claim 1,
wherein the bracket is designed as a multi-part carrier frame.

14. The sowing unit according to claim 1,
further comprising:
a share pressure detection device, by means of which the contact pressure of the sowing unit or a part of the sowing unit on the soil of the agricultural area can be detected, in particular by sensors; and/or
a share pressure adjustment device, by means of which the contact pressure of the sowing unit or of a part of the sowing unit on the soil of the agricultural area can be adjusted, in particular controlled; and/or
a placement depth adjustment device by means of which the guide depth of the tine share can be adjusted to change the furrow depth of the placement furrow; and/or
one or more soil sensors, by means of which properties of the soil can be detected in a sensor-based manner.

15. A precision seeder, comprising
multiple sowing units arranged next to each other transversely to the direction of travel,
wherein one, more or all the sowing units are designed according to claim 1.
